(19) United States
(12) Patent Application Publication
(10) Pub. No.: US 2014/0216362 A1
(43) Pub. Date: Aug. 7, 2014

(54) Protective Poultry Saddle

(71) Applicants: David Michal Marszalec, (US); Jill Yuen Chin Bong, (US)

(72) Inventors: David Michael Marszalec, Morrison, CO (US); Jill Yuen Chin Bong, Morrison, CO (US)

(73) Assignee: Jill Yuen Chin Bong, Morrison, CO (US)

(21) Appl. No.: 13/757,953

(22) Filed: Feb. 4, 2013

(51) Int. Cl. A01K 45/00; A01K 13/00

(52) U.S. Cl. CPC A01K 45/00; A01K 13/006
USPC 119/853

(57) ABSTRACT

A rectangular protective cape-like device worn by poultry that covers the main back of the poultry. Two opposing slits are cut into the main saddle piece to form straps. The saddle holds on to the bird by pulling each wing through the respective slit respective slit Reinforced scrim vinyl or tarp material is used.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING

Not applicable

### BACKGROUND OF INVENTION

### USPC Class: 119853

### Class Name: Animal Husbandry Body Worn Protective Shield or Apparel Bird

A poultry saddle is a cape-like device that is worn by clawed poultry such as chickens, pheasants and turkeys. It protects the backs of the females during mating. It also offers protection from pecking by others in the flock, allowing time for feathers to grow back in.

Reference to patent applications 20110088635 and 20110088635.

Existing poultry saddles are made with too many components and have complicated designs. Material choices such as canvas, denim or cloth make existing saddle designs difficult to clean. These problems increase the cost and price of the final product, making it unaffordable and/or difficult to maintain, especially when worn by larger flocks.

### BRIEF SUMMARY OF INVENTION

Our poultry saddle designs addresses all the problems stated. By simplifying existing designs and using a non-traditional reinforced scrim vinyl or tarp material, we eliminate the need for any sewing—the design can be cut out from one piece of vinyl/tarp material at a low cost. It offers similar poultry protection, is durable, cheap, and can be washed down easily with a water hose.

### BRIEF DESCRIPTION OF DRAWINGS

FIG. 1A shows the design of the poultry saddle (article is two dimensional and is the same for the back and front)

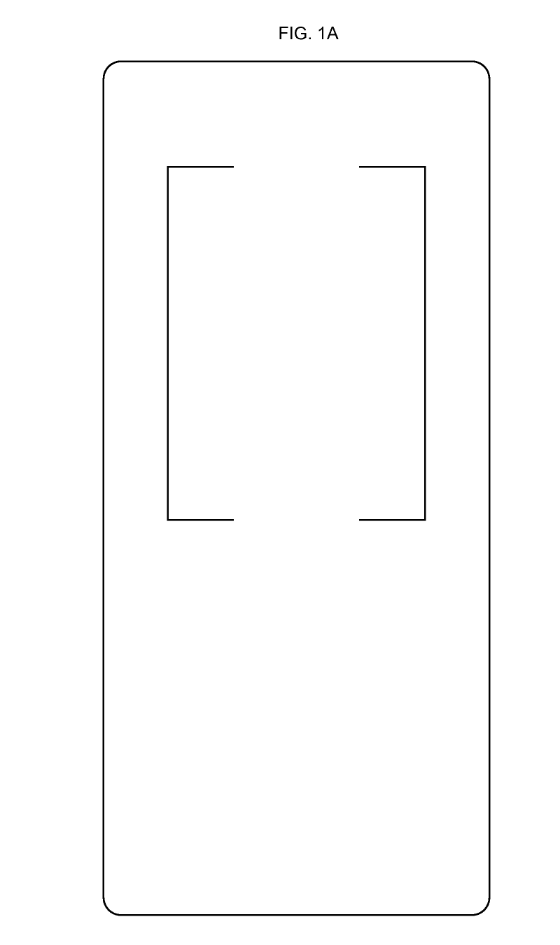

FIG. 1B is the modified design of the poultry saddle where the front includes the application of predator eye decals to help deter predators.

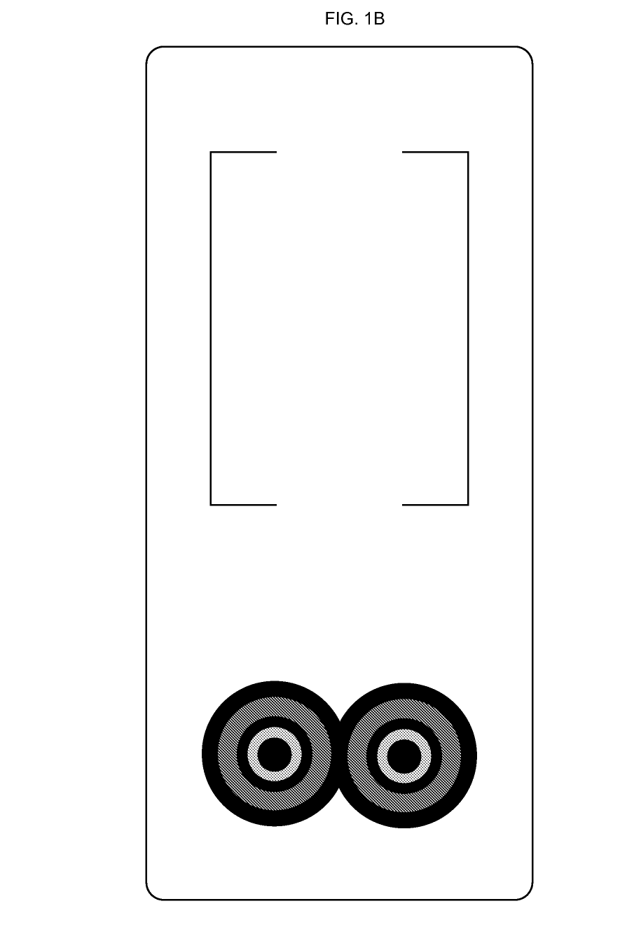

FIG. 1C includes a color variation in the design shown in FIG. 1B

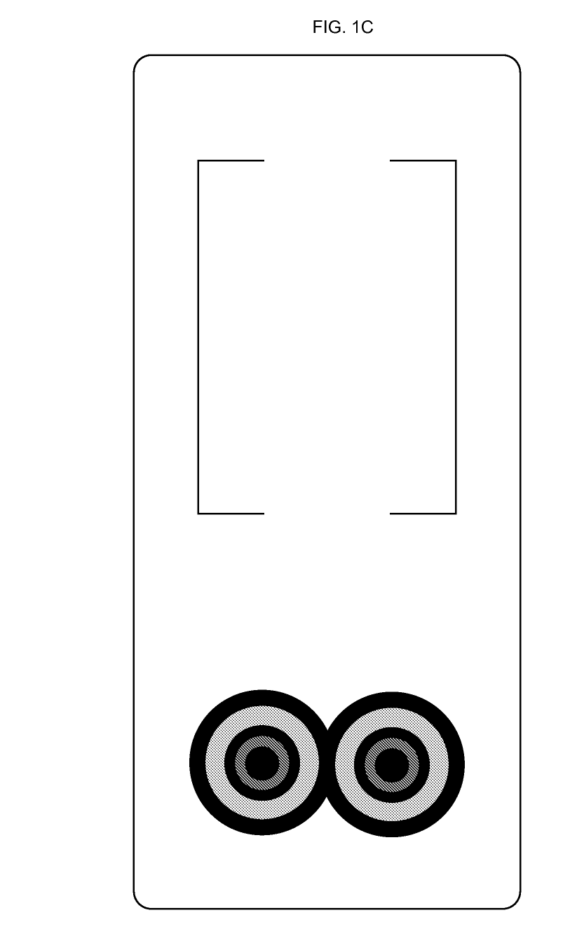

### DETAILED DESCRIPTION OF THE INVENTION

The saddles are made with reinforced scrim vinyl material or tarp material instead of the traditional use of canvas, denim or cloth. A new one-piece design was also developed.

The poultry saddle is cut to size using a mat-cutter. Saddles are cut in the rectangular dimensions of approximately 9.5″×4.25″ for a standard chicken size, or approximately 6.5″×3″ for a bantam-sized chicken. The dimensions may be modified to fit the poultry in question accordingly.

A pair elongated slits that look like this: [ ] are then cut into the saddles.

For the standard sized saddles, the silts are made at about 1″ from the shorter end of the rectangle and approximately 0.75″ from the longer sides of the rectangle. The longest part of the “[” lies parallel to the longer side of the rectangle. The longest part of the slit is about 4″ long and the shorter slits that are perpendicular to it are about 0.6″ long. The distance between the 2 longest sides of the slits is approximately 2.5″.

For the bantam sized saddles, the slits are made at about 0.75″ from the shorter end of the rectangle and approximately 0.75″ from the longer sides of the rectangle. The longest part of the “[” lies parallel to the longer side of the rectangle. The longest part of the slit its about 2.1″ long and the shorter slits that are perpendicular to it are about 0.375″ long. The distance between the 2 longest sides of the slits is approximately 1.5″.

Additional variations in sizes may be customized to fit a specific poultry size.

The outer corners of the saddle are cut away using a pair of scissors such that the cut-off portion is an isosceles triangle.

The internal slits are made using a custom-made template and an exacto knife. The whole saddle may also be die-cut with a custom-made die.

1. The inventors claim the use of reinforced scrim vinyl or tarp material to make the poultry saddles.

2. The inventors claim the design of two slits in a rectangular poultry saddle design.

3. The inventors claim the use of their copyrighted predator eye decals which are applied/stuck on to the saddles.
